(19) United States
(12) Patent Application Publication
(10) Pub. No.: US 2021/0323158 A1
(43) Pub. Date: Oct. 21, 2021

(54) RECOVERY SYSTEM AND METHOD USING MULTIPLE SENSOR INPUTS

(71) Applicant: ABB Schweiz AG, Baden (CH)

(72) Inventors: Biao Zhang, West Hartford, CT (US); Jianjun Wang, West Hartford, CT (US); Yixin Liu, New Britain, CT (US); Saumya Sharma, Hartford, CT (US); Jorge Vidal-Ribas, Sant Cugat del Vallès (ES); Jordi Artigas, Barcelona (ES); Ramon Casanelles, Sant Cugat del Vallès (ES)

(21) Appl. No.: 16/851,928

(22) Filed: Apr. 17, 2020

(51) Int. Cl. B25J 9/16; B25J 13/08

(52) U.S. Cl. CPC B25J 9/1687; B25J 13/085; B62D 65/00; B25J 9/1697; B25J 9/163

(57) ABSTRACT

A system and method for automatic recovery from a failure in a robotic assembly operation using multiple sensor input. Moreover, following detection of an error in an assembly operation from data provided by a first sensor, a recovery plan can be executed, and, if successful, a reattempt at the failed assembly operation can commence. The assembly stage during which the error occurred can be detected by a second sensor that is different from the first sensor. Identification of the assembly stage can assist with determining the recovery plan, as well as identifying the assembly operation that is to be reattempted. The failure can be detected by comparing information obtained from a sensor, such as, for example, a force signature, with corresponding historical information, including historical information obtained at the identified assembly stage for prior workpieces.

### FIELD OF INVENTION

The present invention relates to robotic assembly, and more particularly, to a system and method for using multiple sensor inputs to recover from an assembly failure during a robotic assembly operation.

### BACKGROUND

A variety of operations can be performed during the final trim and assembly (FTA) stage of automotive assembly, including, for example, door assembly, cockpit assembly, and seat assembly, among other types of assemblies. Yet, for a variety of reasons, only a relatively small number of FTA tasks are typically automated. For example, often during the FTA stage, while an operator is performing an FTA operation, the vehicle(s) undergoing FTA is/are being transported on a line(s) that is/are moving the vehicle(s) in a relatively continuous manner. Yet such continuous motions of the vehicle(s) can cause or create certain irregularities with respect to at least the movement and/or position of the vehicle(s), and/or the portions of the vehicle(s) that are involved in the FTA. Moreover, such motion can cause the vehicle to be subjected to movement irregularities, vibrations, and balancing issues during FTA, which can prevent, or be adverse to, the ability to accurately model or predict the location of a particular part, portion, or area of the vehicle that directly involved in the FTA. Further, such movement irregularities can prevent the FTA from having a consistent degree of repeatability in terms of the movement and/or positioning of each vehicle, or its associated component, as each subsequent vehicle and/or component passes along the same area of the assembly line. Accordingly, such variances and concerns regarding repeatability can often preclude the use of traditional teach and repeat position based robot motion control in FTA operations.

Accordingly, although various robot control systems are available currently in the marketplace, further improvements are possible to provide a system and means to calibrate and tune the robot control system to accommodate such movement irregularities.

### BRIEF SUMMARY

An aspect of an embodiment of the present application is a method that can include monitoring, by a plurality of sensors, a movement of a robot during an assembly operation, the assembly operation comprising a plurality of assembly stages. Additionally, a determination can be made as to whether a value obtained by a first sensor of the plurality of sensors while monitoring the movement of the robot exceeds a threshold value. Further, using information from a second sensor of the plurality of sensors, an assembly stage of the plurality of assembly stages can be identified as having been performed by the robot when the value exceeded the threshold value, the second sensor being different than the first sensor. Additionally, a recovery plan for the robot can be determined based on the identified assembly stage, and the robot can be displaced in accordance with the determined recovery plan. Further, the method can include reattempting, after displacement of the robot, the identified assembly stage.

Another aspect of an embodiment of the present application is a method that can include monitoring, by a plurality of sensors, a movement of a robot during an assembly operation, and determining a value obtained by a first sensor of the plurality of sensors while monitoring the movement of the robot exceeds a threshold value. Additionally, a recovery plan can be determined using the value obtained by the first sensor, and the robot can be displaced in accordance with the recovery plan. Further, the recovery plan can be determined to be successful. The method can also include reattempting, after determining the recovery plan was successful, the assembly operation, the reattempted assembly operation being guided by a second sensor of the plurality of sensors, the second sensor being different than the first sensor.

Additionally, an aspect of an embodiment of the present application is a method that can include monitoring a movement of a robot during an assembly operation, monitoring, by a plurality of sensors, a movement of a workpiece during the assembly operation, and time stamping at least the monitored movement of the workpiece. Further, using the time stamped monitored movement of the workpiece, at least a speed of movement of the workpiece and at least one of an acceleration and a deceleration of the workpiece can be determined. The method can also include determining, from the monitored movement of the robot, the monitored movement of the workpiece, the speed of movement of the workpiece, and at least one of the acceleration or the deceleration of the workpiece, a force signature. Additionally, the method can include determining the force signature exceeds a threshold value, and determining, in response to the force signature exceeding the threshold value, a recovery plan for movement of the robot. Additionally the robot can be displaced in accordance with the determined recovery plan, and, after displacement of the robot, the identified assembly stage can be reattempted.

These and other aspects of the present application will be better understood in view of the drawings and following detailed description.

### BRIEF DESCRIPTION OF THE DRAWINGS

The description herein makes reference to the accompanying figures wherein like reference numerals refer to like parts throughout the several views.

FIG. 1 illustrates a schematic representation of at least a portion of an exemplary robot system according to an illustrated embodiment of the present application.

FIG. 2 illustrates a schematic representation of an exemplary robot station through which vehicles are moved by an automatic guided vehicle (AGV) or a conveyor, and in which a robot mounted to a robot base is moveable along, or by, a track.

FIG. 3 illustrates an exemplary component that is to be assembled to a workpiece according to an embodiment of the subject application.

FIG. 4 illustrates an exemplary process for automatic recovery from an assembly failure during a robotic assembly operation according to an embodiment of the subject application.

FIG. 5 illustrates an exemplary graphical representation of a detected force as a robot attempts to assemble a component to a workpiece during at least a portion of an assembly operation according to an embodiment of the subject application.

FIG. 6 illustrates an exemplary process for automatic recovery from an assembly failure during a robotic assembly operation according to an embodiment of the subject application.

The foregoing summary, as well as the following detailed description of certain embodiments of the present application, will be better understood when read in conjunction with the appended drawings. For the purpose of illustrating the application, there is shown in the drawings, certain embodiments. It should be understood, however, that the present application is not limited to the arrangements and instrumentalities shown in the attached drawings. Further, like numbers in the respective figures indicate like or comparable parts.

### DESCRIPTION OF THE ILLUSTRATED EMBODIMENTS

Certain terminology is used in the foregoing description for convenience and is not intended to be limiting. Words such as “upper,” “lower,” “top,” “bottom,” “first,” and “second” designate directions in the drawings to which reference is made. This terminology includes the words specifically noted above, derivatives thereof, and words of similar import. Additionally, the words “a” and “one” are defined as including one or more of the referenced item unless specifically noted. The phrase “at least one of” followed by a list of two or more items, such as “A, B or C,” means any individual one of A, B or C, as well as any combination thereof.

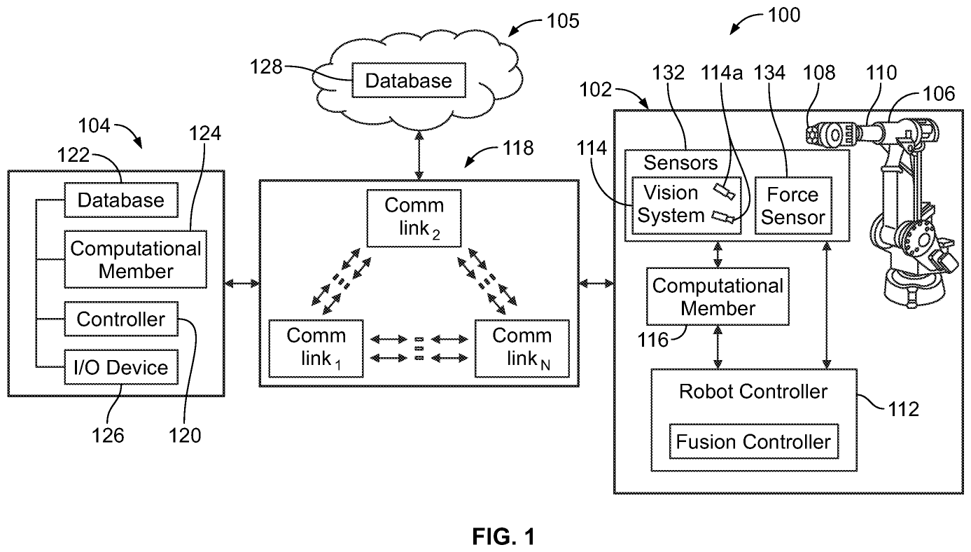

FIG. 1 illustrates at least a portion of an exemplary robot system 100, which can be a sensor fusion robot system, that includes at least one robot station 102 that is communicatively coupled to at least one robotic control system 104, such as, for example, via a communication network or link 118. The robotic control system 104 can be local or remote relative to the robot station 102. Further, according to certain embodiments, the robot station 102 can also include, or be in operable communication with, one or more supplemental database systems 105 via the communication network or link 118. The supplemental database system(s) 105 can have a variety of different configurations. For example, according to the illustrated embodiment, the supplemental database system(s) 105 can be, but is not limited to, a cloud based database.

According to the illustrated embodiment, the robotic control system 104 can include at least one controller 120, a database 122, the computational member 124, and/or one or more input/output (I/O) devices 126. The robotic control system 104 can be configured to provide an operator direct control of the robot 106, as well as to provide at least certain programming or other information to the robot station 102 and/or for the operation of the robot 106. Moreover, the robotic control system 104 can be structured to receive commands or other input information from an operator of the robot station 102 or of the robotic control system 104, including, for example, via commands generated via operation or selective engagement of/with an input/output device 126. Such commands via use of the input/output device 126 can include, but are not limited to, commands provided through the engagement or use of a microphone, keyboard, touch screen, joystick, stylus-type device, and/or a sensing device that can be operated, manipulated, and/or moved by the operator, among other input/output devices. Further, according to certain embodiments, the input/output device 126 can include one or more monitors and/or displays that can provide information to the operator, including, for, example, information relating to commands or instructions provided by the operator of the robotic control system 104, received/transmitted from/to the supplemental database system(s) 105 and/or the robot station 102, and/or notifications generated while the robot 102 is running (or attempting to run) a program or process. For example, according to certain embodiments, the input/output device 126 can display images, whether actual or virtual, as obtained, for example, via use of at least a vision device 114a of a vision guidance system 114.

The robotic control system 104 can include any type of computing device having a controller 120, such as, for example, a laptop, desktop computer, personal computer, programmable logic controller (PLC), or a mobile electronic device, among other computing devices, that includes a memory and a processor sufficient in size and operation to store and manipulate a database 122 and one or more applications for at least communicating with the robot station 102 via the communication network or link 118. In certain embodiments, the robotic control system 104 can include a connecting device that can communicate with the communication network or link 118 and/or robot station 102 via an Ethernet WAN/LAN connection, among other types of connections. In certain other embodiments, the robotic control system 104 can include a web server, or web portal, and can use the communication network or link 118 to communicate with the robot station 102 and/or the supplemental database system(s) 105 via the internet.

The supplemental database system(s) 105, if any, can also be located at a variety of locations relative to the robot station 102 and/or relative to the robotic control system 104. Thus, the communication network or link 118 can be structured, at least in part, based on the physical distances, if any, between the locations of the robot station 102, robotic control system 104, and/or supplemental database system(s) 105. According to the illustrated embodiment, the communication network or link 118 comprises one or more communication links 128 (Comm link_{1-N} in FIG. 1). Additionally, the system 100 can be operated to maintain a relatively reliable real-time communication link, via use of the communication network or link 118, between the robot station 102, robotic control system 104, and/or supplemental database system(s) 105. Thus, according to certain embodiments, the system 100 can change parameters of the communication link 128, including, for example, the selection of the utilized communication links 128, based on the currently available data rate and/or transmission time of the communication links 128.

The communication network or link 118 can be structured in a variety of different manners. For example, the communication network or link 118 between the robot station 102, robotic control system 104, and/or supplemental database system(s) 105 can be realized through the use of one or more of a variety of different types of communication technologies, including, but not limited to, via the use of fiber-optic, radio, cable, or wireless based technologies on similar or different types and layers of data protocols. For example, according to certain embodiments, the communication network or link 118 can utilize an Ethernet installation(s) with wireless local area network (WLAN), local area network (LAN), cellular data network, Bluetooth, ZigBee, point-to-point radio systems, laser-optical systems, and/or satellite communication links, among other wireless industrial links or communication protocols.

The database 122 of the robotic control system 104 and/or one or more databases 128 of the supplemental database system(s) 105 can include a variety of information that can be used in the identification of elements within the robot station 102 in which the robot 106 is operating. For example, one or more of the databases 122, 128 can include or store information that is used in the detection, interpretation, and/or deciphering of images or other information detected by a vision guidance system 114, such as, for example, information related to tracking feature(s) that may be detected in an image(s) captured by the by the vision guidance system 114. Additionally, or alternatively, such databases 122, 128 can include information pertaining to one or more sensors 132, including, for example, information pertaining to forces, or a range of forces, that are to be expected to be detected by via use of one or more force sensors 134 at one or more different locations in the robot station 102 and/or along the workpiece 144 at least as work is performed by the robot 106.

The database 122 of the robotic control system 104 and/or one or more databases 128 of the supplemental database system(s) 105 can also include information that can assist in discerning other features within the robot station 102. For example, images that are captured by the one or more vision devices 114a of the vision guidance system 114 can be used in identifying, via use of information from the database 122, components within the robot station 102, including FTA components that are within a picking bin, among other components, that may be used by the robot 106 in performing FTA on a workpiece, such as, for example, a car body or vehicle.

According to certain embodiments, the robot station 102 includes one or more robots 106 having one or more degrees of freedom. For example, according to certain embodiments, the robot 106 can have, for example, six degrees of freedom. According to certain embodiments, an end effector 108 can be coupled or mounted to the robot 106. The end effector 108 can be a tool, part, and/or component that is mounted to a wrist or arm 110 of the robot 106. Further, at least portions of the wrist or arm 110 and/or the end effector 108 can be moveable relative to other portions of the robot 106 via operation of the robot 106 and/or the end effector 108, such for, example, by an operator of the robotic control system 104 and/or by programming that is executed to operate the robot 106.

The robot 106 can be operative to position and/or orient the end effector 108 at locations within the reach of a work envelope or workspace of the robot 106, which can accommodate the robot 106 in utilizing the end effector 108 to perform work, including, for example, grasp and hold one or more components, parts, packages, apparatuses, assemblies, or products, among other items (collectively referred to herein as “components”). A variety of different types of end effectors 108 can be utilized by the robot 106, including, for example, a tool that can grab, grasp, or otherwise selectively hold and release a component that is utilized in a final trim and assembly (FTA) operation during assembly of a vehicle, among other types of operations.

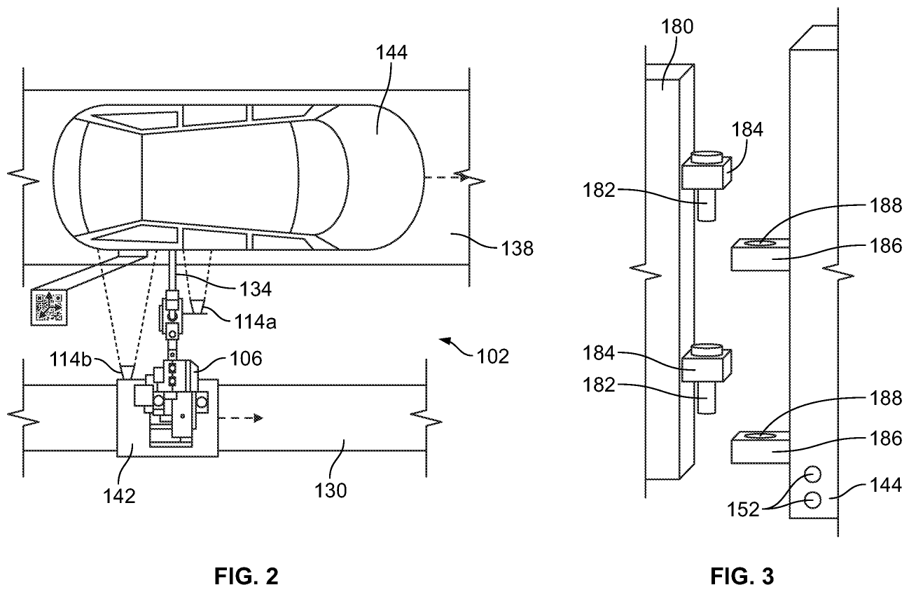

The robot 106 can include, or be electrically coupled to, one or more robotic controllers 112. For example, according to certain embodiments, the robot 106 can include and/or be electrically coupled to one or more controllers 112 that may, or may not, be discrete processing units, such as, for example, a single controller or any number of controllers. The controller 112 can be configured to provide a variety of functions, including, for example, be utilized in the selective delivery of electrical power to the robot 106, control of the movement and/or operations of the robot 106, and/or control the operation of other equipment that is mounted to the robot 106, including, for example, the end effector 108, and/or the operation of equipment not mounted to the robot 106 but which are an integral to the operation of the robot 106 and/or to equipment that is associated with the operation and/or movement of the robot 106. Moreover, according to certain embodiments, the controller 112 can be configured to dynamically control the movement of both the robot 106 itself, as well as the movement of other devices to which the robot 106 is mounted or coupled, including, for example, among other devices, movement of the robot 106 along, or, alternatively by, a track 130 or mobile platform such as the automated guided vehicle (AGV) to which the robot 106 is mounted via a robot base 142, as shown in FIG. 2.

The controller 112 can take a variety of different forms, and can be configured to execute program instructions to perform tasks associated with operating the robot 106, including to operate the robot 106 to perform various functions, such as, for example, but not limited to, the tasks described herein, among other tasks. In one form, the controller(s) 112 is/are microprocessor based and the program instructions are in the form of software stored in one or more memories. Alternatively, one or more of the controllers 112 and the program instructions executed thereby can be in the form of any combination of software, firmware and hardware, including state machines, and can reflect the output of discreet devices and/or integrated circuits, which may be co-located at a particular location or distributed across more than one location, including any digital and/or analog devices configured to achieve the same or similar results as a processor-based controller executing software or firmware based instructions. Operations, instructions, and/or commands determined and/or transmitted from the controller 112 can be based on one or more models stored in non-transient computer readable media in a controller 112, other computer, and/or memory that is accessible or in electrical communication with the controller 112.

According to the illustrated embodiment, the controller 112 includes a data interface that can accept motion commands and provide actual motion data. For example, according to certain embodiments, the controller 112 can be communicatively coupled to a pendant, such as, for example, a teach pendant, that can be used to control at least certain operations of the robot 106 and/or the end effector 108.

The robot station 102 and/or the robot 106 can also include one or more sensors 132, as well as other forms of input devices. Examples of sensors 134 that may be utilized in connection with the operation of the robot 106, and which may also provide information to a fusion controller 140 for sensor fusion includes, for example, vision sensors, force sensors, motion sensors, acceleration sensors, and/or depth sensors, among other types of sensors. Further, information provided by at least some of the sensors 132 can be integrated, including, for example, via operation of a fusion controller 140, such that operations and/or movement, among other tasks, by the robot 106 can at least be guided via sensor fusion. Such a fusion controller 140 can be part of, or otherwise communicatively coupled to, a controller 112 and/or a computational member 116 of the robotic control system 104. Moreover, information provided by the one or more sensors 132, such as, for example, the vision guidance system 114 and force sensors 134, among other sensors 132, can be processed by the fusion controller 140 such that the information provided by the different sensors 132 can be combined or integrated in a manner that can reduce the degree of uncertainty in the movement and/or performance of tasks by the robot 106. Thus, according to certain embodiments, at least a plurality of the sensors 132 can provide information to the fusion controller 140 that the fusion controller 140 can use to determine a location to which the robot 106 is to move and/or to which the robot 106 is to move a component that is to be assembled to a workpiece. Further, the fusion controller 140 can also be communicatively coupled to the exchange information and data with the robot 106.

According to the illustrated embodiment, the vision guidance system 114 can comprise one or more vision devices 114a, 114b that can be used in connection with observing at least portions of the robot station 102, including, but not limited to, observing, workpieces 144 and/or components that can be positioned in, or are moving through or by at least a portion of, the robot station 102. For example, according to certain embodiments, the vision guidance system 114 can visually detect, track, and extract information, various types of visual features that can be part of, or otherwise positioned on or in proximity to, the workpiece 144 and/or components that are in the robot station 102. For example, the vision guidance system 114 can track and capture images of, as well as possibly extract information from such images, regarding visual tracking features that are part of, or positioned on a FTA component and/or car body that is/are involved in an assembly process, and/or on automated guided vehicle (AGV) that is moving the workpiece through the robot station 102.

Examples of vision devices 114a, 114b of the vision guidance system 114 can include, but are not limited to, one or more imaging capturing devices, such as, for example, one or more two-dimensional, three-dimensional, and/or RGB cameras. Additionally, the vision devices 114a, 114b can be mounted at a variety of different locations within the robot station 102, including, for example, mounted generally above the working area of the robot 106, mounted to the robot 106, the end effector 108 of the robot 106, and/or the base 142 on which the robot 106 is mounted and/or displaced, among other locations. For example, FIG. 2 illustrates a robot station 102 in which a first vision device 114a is attached to a robot 106, and a second vision device 114b is mounted to the robot base 142 onto which the robot 106 is mounted. Further, according to certain embodiments, one or more vision devices 114a, 114b can be positioned at a variety of different locations at which the vision device 114b generally does not move, among other locations.

According to certain embodiments, the vision guidance system 114 can have data processing capabilities that can process data or information obtained from the vision devices 114a, 114b. Additionally, such processed information can be communicated to the controller 112 and/or fusion controller 140. Alternatively, according to certain embodiments, the vision guidance system 114 may not have data processing capabilities. Instead, according to certain embodiments, the vision guidance system 114 can be electrically coupled to a computational member 116 of the robot station 102 that is adapted to process data or information outputted from the vision guidance system 114. Additionally, according to certain embodiments, the vision guidance system 114 can be operably coupled to a communication network or link 118, such that information outputted by the vision guidance system 114 can be processed by a controller 120 and/or a computational member 124 of the robotic control system 104, as discussed below.

Thus, according to certain embodiments, the vision guidance system 114 or other component of the robot station 102 can be configured to search for certain tracking features within an image(s) that is/are captured by the one or more vision devices 114a, 114b and, from an identification of the tracking feature(s) in the captured image, determine position information for that tracking feature(s). Information relating to the determination of a location of the tracking feature(s) in the captured image(s) can be used, for example, by the vision servcing of the control system 104, as well as stored or recorded for later reference, such as, for example, in a memory or database of, or accessible by, the robotic control system 104 and/or controller 112. Moreover, information obtained by the vision guidance system 114 can be used to at least assist in guiding the movement of the robot 106, the robot 106 along a track 130 or mobile platform such as the AGV 138, and/or movement of an end effector 108.

According to certain embodiments, the first and second vision devices 114a, 114b can each individually track at least artificial tracking features and/or natural tracking features. Artificial tracking features can be features that are configured to be, and/or are at a location in the robot station 102, that may be less susceptible to noise, including, for example, noise associated with lighting, movement irregularities, vibrations, and balancing issues, than natural tracking features. Thus, such artificial tracking features can be, but are not limited to, items and/or features that are configured and/or position primarily for use by the vision guidance system 114, and can include, but are not limited to, a quick response (QR) code 150, as shown, for example, in FIGS. 2 and 3. Alternatively, or additionally, rather than utilizing artificial tracking features, portions of the workpiece 144, or related components, can be utilized that are at a location that is generally less susceptible to noise, including noise associated with movement caused by natural forces, than other portions of the workpiece 144.

With respect to natural tracking features, such features can include, but are not limited to, features of the workpiece 144 at or around the location at which a component will be located, contacted, moved, and/or identified along the workpiece 144 during actual operation of the robot 106. For example, FIG. 3 provides one example of natural tracking features in the form of side holes 152 in a workpiece 144. Thus, the natural tracking features may be related to actual intended usage of the robot 106, such as, for example locating relatively small holes 152 that will be involved in an assembly operation.

For example, referencing the example provided in FIG. 3, and in connection with an exemplary assembly operation in which the robot 106 is to secure a door 180 to a workpiece 144 in the form of a car body via one or more door hinges, one or more of the vision devices 114a, 114b can track holes 188 in body hinge portions 186 that are secured to a car body, and which are to receive insertion of pins 182 from door hinge portions 184 that are mounted to the door 180. According to such an embodiment, the one or more hole(s) 188 that is/are being tracked by the one or more vision devices 114a, 114b can be positioned and sized such that the hole(s) 188 Accordingly, in view of at least the size, location, and/or configuration, among other factors, natural tracking features can be inherently more susceptible to a relatively higher level of noise than the artificial tracking features. As such relatively higher levels of noise can adversely affect the reliability of the information obtained by the sensors 132, artificial tracking features may be used during different stages of an assembly process than natural tracking features.

The force sensors 134 can be configured to sense contact force(s) during the assembly process, such as, for example, a contact force between the robot 106, the end effector 108, and/or a component being held by the robot 106 with the workpiece 144 and/or other component or structure within the robot station 102. Such information from the force sensor(s) 134 can be combined or integrated, such as, for example, by the fusion controller 140, with information provided by the vision guidance system 114, including for example, information derived in processing images of tracking features, such that movement of the robot 106 during assembly of the workpiece 144 is guided at least in part by sensor fusion.

FIG. 2 illustrates a schematic representation of an exemplary robot station 102 through which workpieces 144 in the form of car bodies are moved by the automated or automatic guided vehicle (AGV) or conveyor 138, and which includes a robot 106 that is mounted to a robot base 142 that is moveable along, or by, a track 130 or mobile platform such as the AGV 138 or fixed on ground. While for at least purposes of illustration, the exemplary robot station 102 depicted in FIG. 2 is shown as having, or being in proximity to, a workpiece 144 and associated AGV 138, the robot station 102 can have a variety of other arrangements and elements, and can be used in a variety of other manufacturing, assembly, and/or automation processes. Additionally, while the examples depicted in FIGS. 1 and 3 illustrate a single robot station 102, according to other embodiments, the robot station 102 can include a plurality of robot stations 102, each station 102 having one or more robots 106. The illustrated robot station 102 can also include, or be operated in connection with, one or more AGVs 138, supply lines or conveyors, induction conveyors, and/or one or more sorter conveyors. According to the illustrated embodiment, the AGV 138 can be positioned and operated relative to the one or more robot stations 102 so as to transport, for example, workpieces 144 that can receive, or otherwise be assembled with or to include, via operation of the robot 106, one or more components. For example, with respect to embodiments in which the workpiece 144 is a car body or vehicle, such components can include a door assembly, cockpit assembly, and seat assembly, among other types of assemblies and components.

Similarly, according to the illustrated embodiment, the track 130 can be positioned and operated relative to the one or more robots 106 so as to facilitate assembly by the robot(s) 106 of components to the workpiece(s) 144 that is/are being moved via the AGV 138. Moreover, the track 130 or mobile platform such as the AGV, robot base 142, and/or robot can be operated such that the robot 106 is moved in a manner that at least generally follows the movement of the AGV 138, and thus the movement of the workpiece(s) 144 that is/are on the AGV 138. Further, as previously mentioned, such movement of the robot 106 can also include movement that is guided, at least in part, by information provided by the vision guidance system 114, one or more force sensor(s) 134, among other sensors 132.

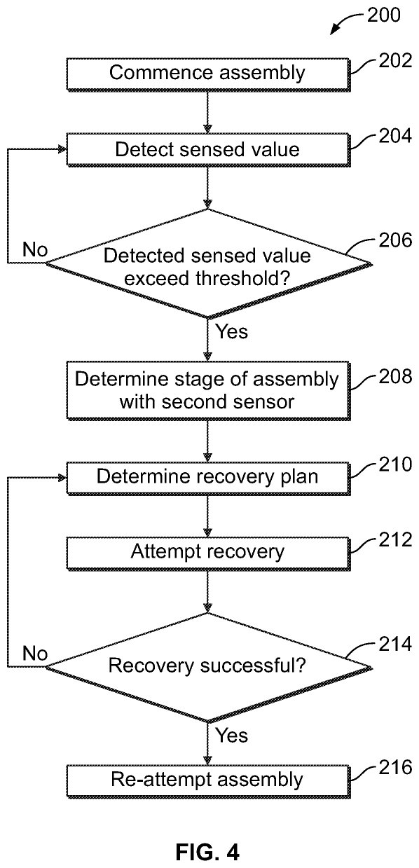

FIG. 4 illustrates an exemplary process 200 for automatic recovery from an assembly failure during a robotic assembly operation according to an embodiment of the subject application. The operations illustrated for all of the processes in the present application are understood to be examples only, and operations may be combined or divided, and added or removed, as well as re-ordered in whole or in part, unless explicitly stated to the contrary. At step 202, the process 200 can begin with the commencement of an assembly cycle. According to certain embodiments, the robotic assembly cycle can comprise a plurality of assembly steps, stages, or segments that can be directed to assembly of a particular component(s) to the workpiece 144. For example, for at least purposes of discussion, referencing FIG. 3, according to certain embodiments, the assembly cycle can involve a series of assembly stages involving the robot 106 assembling a component, such as, for example, a door 180 to a workpiece 144 that is moving along the AGV 138. In such an example, the different assembly stages can include, but are not limited to, for example: (1) the robot 106 positioning the door 180 at a first assembly stage location at which the door 180 is in relatively close proximity to the continuously moving workpiece 144, (2) the robot 106 positioning the door 180 at a second assembly stage location at which a pin(s) 182 of a door hinge portion(s) 184 that is/are secured to the door 180 are positioned above and in alignment with a mating hole(s) 188 in a corresponding body hinge portion(s) 186 that is/are secured to the workpiece 144, and (3) the robot 106 positioning the door 180 at a third assembly stage location at which the pin(s) 182 of the door hinge portion(s) 184 is/are inserted into the hole(s) 188 of the corresponding body hinge portion(s) 186. However, the number of assembly stages, and the specific aspects or tasks associated with those assembly stages, can vary based on a variety of different circumstances and criteria, including, but not limited to, the type of workpiece and associated assembly procedures.

As previously discussed, during the assembly stages, a variety of different types sensors 132 can provide information that assist in guiding the movement or operation of the robot 106, including, but not limited to vision devices 114a, 114b of the vision guidance system 114 and force sensors 134. For example, according to the illustrated embodiment, during at least a portion of an assembly stage, information from a first sensor, such as, for example, a vision device 114a, can be used to guide movement of the robot 106, such as, for example, movement relating to inserting the pin(s) 182 of the door hinge portion(s) into the hole(s) 188 of the corresponding body hinge portion(s) 186. During this process, information or data obtained by the vision device 114a, as well as information obtained from other sensors 132, can be detected or monitored at step 204. For example, while information obtained by the vision device 114a can be used in connection with the assembly procedure involving the robot 106 moving the door 180 so as to insert the pin(s) 182 into the corresponding hole(s) 188, at step 204 information obtained from a second, different sensor, such as, for example, a force sensor 134, can also be monitored or detected during that assembly procedure.

Such monitoring at step 204 can include detecting values or information obtained from the sensors 132 that may exceed threshold levels or values. Moreover, at step 206, a determination can be made, such as, for example, by the fusion controller 140 or other controller or system of the robot system 102, as to whether any of the information or data detected at step 204 exceeds an associated threshold level(s) or value(s). For example, with respect to the previous example in which information or data from the vision device 114a is being used to guide the robot 106 moving the door 180 so as to insert the pin(s) 182 into the corresponding hole(s) 188, at step 206 information obtained from the force sensor 134 can be examined to determine whether the corresponding data or information from the force sensor 134 exceeds a threshold level(s) or amount(s). Further, the threshold value could be a numerical number, or other representation, such as, for example, a force signature. In certain embodiments, upon the threshold being exceeded, a failure mode can be triggered that stops the robot 106 or an associated tool from continuing to operate in a direction that was associated with the force exceeding the threshold value.

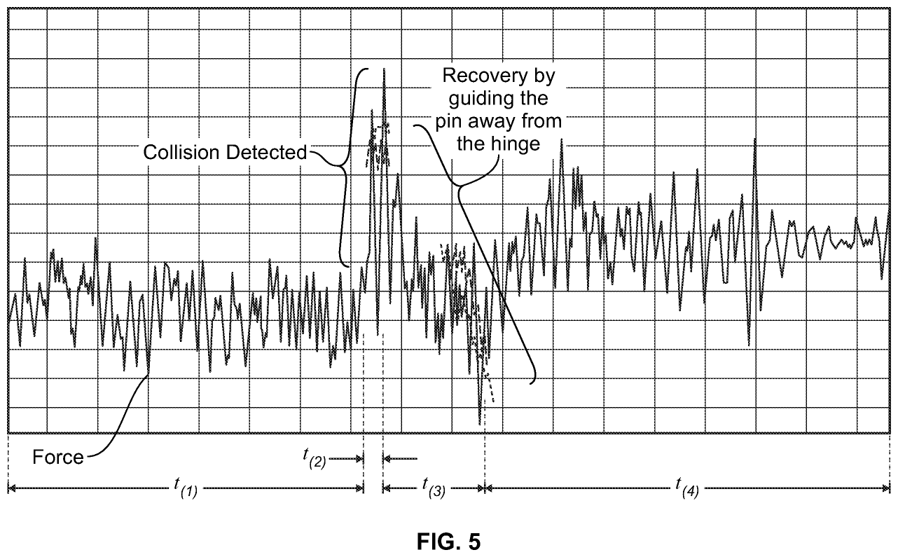

For example, FIG. 5 depicts example force data, as detected using the force sensor 134 during at least a portion of an assembly operation. As seen, after a first time period (t₁) in which the force sensed by the force senor 134 is generally consistent, the force measured during a second time period (t₂) relatively quickly elevates to a relatively high level, thereby resulting in a relatively large force signature, as seen in FIG. 5. According to the illustrated embodiment, such a relatively high level of detected force, and/or the associated force signature, can exceed the threshold value, thereby indicating occurrence of an error in the assembly process and/or a failure or other error of the force sensor 134. For purposes of discussion, in the illustrated example, such a force signature during the second time period (t₂) is indicative that one or more other sensors 132 did not provide accurate information, which resulted in the pin(s) 182 in the door hinge body portion 184 not being properly aligned for insertion into the hole(s) 188. As a consequence, the data shown in FIG. 5 can indicate that while the vision device 114a is providing information indicating that the robot 106 is move the door 180 in a downward direction, the pin(s) 182 are being pressed against a wall of the body hinge portion 186, and thus are not, and cannot be, inserted into the mating hole(s) 188.

Additionally, the force signature shown in FIG. 5 can be depict in connection with three-dimensional directional information (e.g., the illustrated force signature can be graphed in FIG. 5 along the horizontal (x, y) and vertical (z) directions). Thus, in addition to obtaining information indicating that the threshold value with respect to at least force and torque was exceeded, the information obtained at step 204 can also indicate the direction of the excessive force and/or the direction of the movement of the robot 106/component that was held by the robot 106 when the failure occurred.

At step 210, a plan for recovering from the failure can be determined. According to certain embodiments in which the direction of movement of the robot 106 and/or the component held by the workpiece was known when the failure occurred, the recovery plan can include moving the robot 106 and/or component in a direction opposite of that which the robot 106 and/or component were traveling when the error occurred. Thus, for example, if the error occurred when the robot 106 had moved the door downwardly in an unsuccessful attempt to insert the pin(s) 182 in the mating hole(s) 188, as indicated by the information and/or force signature provided in FIG. 5, then at step 210, a determination can be made that the recovery plan is to include operating the robot 106 in a manner that moves the door 180 that is being held by the robot 106, and thus the associated pin(s) 182, in the opposite direction, namely upward and away from the hole(s) 188. According to such embodiments, in arriving at such a recovery plan, or at least such a portion of the recovery plan, by utilizing the force information, information provided by other sensors 132, such as, for example, the vision guidance system 114, can at least initially be ignored. Further, according to such an embodiment, the process can then proceed to step 212, wherein the robot 106 can then be at least moved in a direction that is opposite of that which the robot 106 and/or component were traveling when the error occurred.

Alternatively, according to certain embodiments, following detection of the threshold value being exceeded at step 206, at step 208 the process 200 can utilize a different sensor in connection with identifying the assembly stage during which the failure occurred. For example, as the threshold value was determined to have been exceeded based on information or data from the force sensor 134, then at step 208, a different sensor, such as, for example, the vision device 114a of the vision guidance system 114, can be used in connection with determining which assembly stage of the assembly cycle did the failure occur. According to such an embodiment, knowledge of the assembly stage can assist with the determination of an appropriate recovery plan.

For example, according to certain embodiments, the vision device 114a can provide information regarding the relative positions of the pin(s) 182 and the mating hole(s) 188 at least at, or around, the time of failure, which can provide an indication of whether the failed assembly stage involved positioning the pin(s) 182 above the mating hole(s) 188, or if the failed assembly stage involved the insertion of the pin(s) 182 into the mating hole(s) 188.

At step 210, based on the identified assembly stage, commands can be generated that move the robot 106 and/or the associated component that is being held by the robot 106 to a position that corresponds to the beginning of that identified assembly stage, or, alternatively, to an intermediate position after the commencement of that assembly stage and prior to the detected failure. Further, such a recovery plan can also include correcting a prior position of the robot 106 and associated component. For example, based on the position of the robot 106 and the associated component, as well as a known position of the workpiece 144, a determination can be made to alter the prior position of the robot 106 such that, when the assembly process is to be re-attempted, the assembly process 200 does not experience the same failure.

For example, if the determination at stage 210 is that the robot 106 was moving the door 180 to insert the pin(s) into the corresponding hole(s) 188, then at step 210 a controller of the robot system 100 can determine that the recovery plan is to operate the robot 106 so as to lift the door 180 in a manner that displaces the pin(s) 182 in the door body hinge portion(s) 184 away from the corresponding hole(s) 188 in the body hinge portion(s) 186. Moreover, using information as to the assembly stage during the time of the failure, a controller can determine that the recovery plan will at least include the robot 106 moving the door 180 away from the body hinge portion(s) 186 in a manner that can result in the pin(s) 182 of the door hinge portion(s) 184 being repositioned above the corresponding hole(s) 188 in the body hinge portion(s) 186.

Additionally, according to certain embodiments, the recovery plan can also include adjusting a prior location of the robot 106 and/or component such that the prior error is not repeated. For example, with respect to the previously discussed example, in an effort to avoid replicating the same collision, such a recovery plan can include re-adjusting the location at which the pin(s) 182 were previously held over the mating hole(s) 188 so as to at least attempt to more accurately align the pin(s) 182 with the hole(s) 188. Such an adjustments can be determined for example, by a controller of the robot system 102 using at least knowledge of the location of the workpiece 144 and/or the location of the hole(s) 188, as well as knowledge of the location of the robot 106, and thus knowledge of the location of the door 180, and associated pin(s) 182 being held by the robot 106. Such knowledge of locations can be obtained from a variety of sources, including, but not limited to, use of the vision guidance system 114, monitored movement of the workpiece 144 and robot 106, and/or historical information, among other sources of information.

At step 212, the recovery plan determined at step 210 can be implemented to operate the robot 106, and thus move the component being held by the robot 106. Moreover, at step 212, commands relating to the determined recovery plan can be used to move the robot 106 and the associated component that is being held by the robot 106 away from the position associated with the detected failure. Referencing the example shown in FIG. 5, step 212 can be seen during the third time period (t₃). As seen in this example, by operating the robot 106 during step 212 to guide the pin(s) 182 away from the body hinge portion 186, the force detected by the force sensor 134 decreases. Further, according to certain embodiments, the attempted recovery at step 212 can continue to use the first sensor, such as, for example, the vision device 114a, in providing commands for moving the robot 106. For example, with respect to the prior door 180 example, the vision device 114a, and associated vision guidance system 114 can be used in connection with providing instructions that position the robot 106 such that the pin(s) 182 of the door 180 that is being held by the robot 106 is/are moved to a location that is at least above the body hinge portion 186, as well as move the robot 106 such that the pin(s) 182 also is/are aligned with the mating hole(s) 188 in the body hinge portion 186.

At step 214, a determination is made as to whether the recovery performed at step 212 was successful. Whether the recovery was successful can be determined in a variety of different manners. For example, according to certain embodiments, whether the recovery was successful can be at least partially based on information or data provided by a sensor 132 other than the sensor 132 that was identified as having a detected value exceed a threshold, as discussed above with respect to step 206. Thus, in the current example, as detected information from the force sensor 134, such as, for example, the force signature shown during the second time period (t₂) in FIG. 5, used in connection with detecting the error, at step 214 information or data from another sensor, such as, for example, from the first vision device 114a, can be used in connection with evaluating whether the recovery attempted at step 212 was, or was not, successful. For example, the vision device 114a can provide information indicating, based on the relative positions of the pin(s) 182 of the mating hole(s) 188, if the recovery was successful. Further, according to such an embodiment, information from the vision device 114a indicating that the pin(s) 182 also is/are aligned with the mating hole(s) 188 in the body hinge portion 186 can also provide an indication that the recovery was successful.

Additionally, or alternatively, in at least certain instances, whether the recovery was successful can also be determined by information or data from the sensor 132 that was used at step 206 to identify the existence of the failure. For example, in the illustrated embodiment, information or data provided by the force sensor 134 can provide an indication of whether the detected force or torque has dropped below the threshold level and/or is within range of corresponding historical information. For example, with reference to the example provided in FIG. 5, the previously discussed reducing of force seen during the third time period (t₃), and/or the relatively constant lower force seen during a subsequent fourth time period (t₄) can provide an indication that the displacement of the pin(s) 182 away from the mating hole(s) 188 in the body hinge portion 186 has resolved the detected failure, and thus the recovery has been successful.

If the recovery performed at step 212 is determined at step 214 to have been successful, then at step 216, the process 200 can re-attempt the assembly that was being performed, or otherwise was interrupted, by the detected failure. Thus, according to certain embodiments, the recovery plan of step 210 can include positioning the robot 106 and/or workpiece 144 such that, at the end of step 212, the assembly process, or assembly stage, that was previously being performed at the time of the failure can resume. Alternatively, in the event the recovery plan is determined to not have been successful at step 214, then according to certain embodiments, the process can return to step 210, where a controller of the robot system 100 can, using information obtained in connection with the determination that the recovery was unsuccessful, determine another recovery plan that can be implemented.

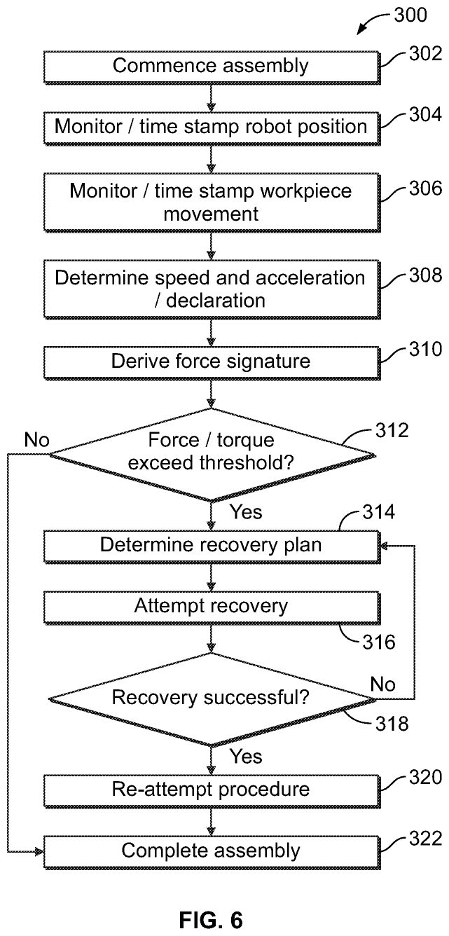

FIG. 6 illustrates an exemplary process 300 for automatic recovery from an assembly failure during a robotic assembly operation according to an embodiment of the subject application. At step 302, the assembly can commence. At step 304, a location of the robot 106 can be monitored. Similarly, at step 306, the movement of the workpiece 144 can be monitored, including, for example, via use of visual information obtained by at least the vision guidance system 114 and via contact forces detected by a force sensor(s) 134. Additionally, as the location of the robot 106 and movement of the workpiece 144 can be generally continuously monitored, the information received at steps 304 and 306 can be time stamped. Additionally, at step 308, through a comparison of the positional information obtained, and time stamped, at different time periods, during step 306, information regarding the speed of movement of the workpiece 144, as well as the acceleration or deceleration of the workpiece 144, can be determined.

The information obtained at steps 304, 306, and 308, including the monitored movement of the robot 106, and the detected contact forces, visual positional information, and information regarding speed and acceleration/declaration of the workpiece 144, can then be inputted into a control loop to determine, at step 310, an associated force signature. For example, depending on the assembly stage and the current operation being performed by the robot 106, step 310 can provide a force signature similar to the force signatures seen during the first, second, third, and fourth time periods (t₁, t₂, t₃, t₄) shown in FIG. 5, among other force signatures.

At step 312, the force signature derived at step 310 can be compared to the threshold value, such as, for example, historical force signatures obtained from prior assembly operations during a similar assembly stage or location of assembly. If the derived force signature is determined to exceed the threshold value, then similar to the steps 206-216 the process 300 can continue with a recovery process. Moreover, similar to steps 206-216 discussed above, the process 300 shown in FIG. 6 can, in a similar manner, also determine a recovery plan at step 314, attempt recovery at step 316 via operation of the robot 106 in accordance with the determined recovery plan, and, if the attempted recovery is determined at step 318 to be successful, re-attempt the assembly procedure at step 320 before continuing with completing the assembly at step 322. The determination of a recovery plan at step 314 can also be based on the force signature, the position of the workpiece, the speed of movement of the workpiece, the acceleration or deceleration of the workpiece, among other considerations, and can use artificial intelligence (AI), for example machine learning, deep learning, to predict the recovery plan.

While the invention has been described in connection with what is presently considered to be the most practical and preferred embodiment, it is to be understood that the invention is not to be limited to the disclosed embodiment(s), but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore it should be understood that while the use of the word preferable, preferably, or preferred in the description above indicates that feature so described may be more desirable, it nonetheless may not be necessary and any embodiment lacking the same may be contemplated as within the scope of the invention, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

1. A method comprising:
monitoring, by a plurality of sensors, a movement of a robot during an assembly operation, the assembly operation comprising a plurality of assembly stages;
determining a value obtained by a first sensor of the plurality of sensors while monitoring the movement of the robot exceeds a threshold value;
identifying, using information from a second sensor of the plurality of sensors, an assembly stage of the plurality of assembly stages that was being performed by the robot when the value exceeded the threshold value, the second sensor being different than the first sensor;
determining, based on the identified assembly stage, a recovery plan for the robot;
displacing the robot in accordance with the determined recovery plan; and
reattempting, after displacement of the robot, the identified assembly stage.

2. The method of claim 1, further including the step of determining if the recovery plan succeeded, and wherein reattempting the identified assembly stage is predicated on the determination that the recovery plan was successful.

3. The method of claim 1, wherein the first sensor is a force sensor.

4. The method of claim 3, wherein the step of determining the value exceeds the threshold value comprises comparing a force signature obtained using the force sensor with a historical force signature.

5. The method of claim 4, wherein the historical force signature is based on force signatures from prior assembly operations during the identified assembly stage.

6. The method of claim 4, wherein the second sensor is a vision device of a vision guidance system.

7. The method of claim 1, wherein determining the recovery plan is further based, in part, on information detected by the second sensor.

8. The method of claim 1, further including the steps of:
determining if the recovery plan was successful;
adjusting, if the recovery plan is determined to not have been successful, the recovery plan to provide an adjusted recovery plan.

9. A method comprising:
monitoring, by a plurality of sensors, a movement of a robot during an assembly operation;
determining a value obtained by a first sensor of the plurality of sensors while monitoring the movement of the robot exceeds a threshold value;
determining, using the value obtained by the first sensor, a recovery plan for movement of the robot;
displacing the robot in accordance with the recovery plan;
determining the recovery plan was successful;
reattempting, after determining the recovery plan was successful, the assembly operation, the reattempted assembly operation being guided by a second sensor of the plurality of sensors, the second sensor being different than the first sensor.

10. The method of claim 9, wherein the first sensor is a force sensor, and wherein the step of determining the value exceeds the threshold value comprises comparing a force signature obtained using the force sensor with a historical force signature.

11. The method of claim 10, wherein the determined recovery plan is based at least in part on directional information obtained from the force signature.

12. The method of claim 10, wherein the second sensor is a vision device of a vision guidance system.

13. The method of claim 9, further including the step of identifying an assembly stage of a plurality of assembly stages of the assembly operation during which the value exceeded the threshold value, and wherein the reattempted assembly operation is based on the identified assembly stage.

14. The method of claim 13, wherein the first sensor is a force sensor, and wherein the step of determining the value exceeds the threshold value comprises comparing a force signature obtained using the force sensor with a historical force signature obtained from prior assembly operations during the identified assembly stage.

15. A method comprising:
monitoring a movement of a robot during an assembly operation;
monitoring, by a plurality of sensors, a movement of a workpiece during the assembly operation;
time stamping at least the monitored movement of the workpiece;
determining, using the time stamped monitored movement of the workpiece, at least a speed of movement of the workpiece and at least one of an acceleration and a deceleration of the workpiece;
determining, from the monitored movement of the robot, the monitored movement of the workpiece, the speed of movement of the workpiece, and at least one of the acceleration or the deceleration of the workpiece, a force signature;
determining the force signature exceeds a threshold value;
determining, in response to the force signature exceeding the threshold value, a recovery plan for movement of the robot;
displacing the robot in accordance with the determined recovery plan; and
reattempting, after displacement of the robot, the identified assembly stage.

16. The method of claim 15, wherein the step of determining the force signature exceeds the threshold value comprises comparing the force signature with a historical force signature.

17. The method of claim 15, wherein the determined recovery plan is based at least in part on directional information obtained from the force signature.

18. The method of claim 15, further including the step of identifying an assembly stage of a plurality of assembly stages of the assembly operation during which the force signature exceeds a threshold value.

19. The method of claim 18, wherein reattempting the identified assembly stage comprises moving the robot in accordance with the identified assembly stage.

20. The method of claim 18, wherein the step of determining the force signature exceeds the threshold value comprises comparing the force signature with a historical force signature that is based on force signatures from prior assembly operations during the identified assembly stage.
